(19) United States
(12) Patent Application Publication
(10) Pub. No.: US 2014/0019093 A1
(43) Pub. Date: Jan. 16, 2014

(54) INCREMENTALLY INCREASING SYSTEM TEST WORKLOAD

(71) Applicant: Joel L. Masser, San Jose, CA (US)

(72) Inventor: Joel L. Masser, San Jose, CA (US)

(73) Assignee: INTERNATIONAL BUSINESS MACHINES CORPORATION, Armonk, NY (US)

(21) Appl. No.: 13/550,269

(22) Filed: Jul. 16, 2012

(51) Int. Cl. G06F 15/00

(52) U.S. Cl. 702/186

(57) ABSTRACT

Embodiments relate to reliability testing of a computer system by gradually and automatically increasing a workload of the computer system. A method of testing a computer system includes running a reliability testing program of a computer system by running the computer system under a workload and gradually and automatically increasing the workload over time until a termination condition is detected.

### BACKGROUND

Embodiments of the present disclosure relate to increasing a system test workload, and in particular to incrementally increasing a system workload to test a stress of the system.

System tests are performed to gauge the ability of software systems to handle stresses such as high workloads. Systems may be tested by generating tests having stress levels that are at, or slightly above, the limits of the system being tested, which may make it difficult to identify the source of errors that arise during testing. When the system is tested at a high level of stress, many errors may occur at once, or one error may be compounded over time, making identification of the source of the error difficult.

### SUMMARY

Exemplary embodiments include a method including running a reliability testing program of a computer system by running, by a processor, the computer system under a workload and gradually and automatically increasing, by the processor, the workload over time until a termination condition is detected.

Additional exemplary embodiments include a computer program product including a tangible storage medium readable by a processing circuit of a computer and storing instructions for execution by the processing circuit for performing a method. The method includes running a reliability testing program of a computer system by running the computer system under a workload and gradually and automatically increasing, by the processing circuit, the workload over time until a termination condition is detected.

Further exemplary embodiments include a computer system including memory and at least one central processing unit (CPU). The CPU is configured to perform a reliability test of the computer system by running the computer system under a workload and gradually and automatically increasing the workload over time until a termination condition is detected.

Other embodiments and aspects of the present disclosure are described in detail herein and are considered a part of the claimed invention. For a better understanding of advantages and features of the embodiments, refer to the description and to the drawings.

### BRIEF DESCRIPTION OF THE SEVERAL VIEWS OF THE DRAWINGS

The subject matter which is regarded as embodiments of the present disclosure is particularly pointed out and distinctly claimed in the claims at the conclusion of the specification. The forgoing and other features, and advantages of the embodiments are apparent from the following detailed description taken in conjunction with the accompanying drawings in which:

FIG. 1 illustrates a block diagram of a computer system according to an embodiment of the present disclosure;

FIG. 2 illustrates a block diagram of a computer system according to another embodiment;

FIG. 3 illustrates a block diagram of a computer system according to another embodiment;

FIG. 4 illustrates a block diagram of a computer system according to another embodiment;

FIG. 5 illustrates a portion of a test program according to one embodiment;

FIG. 6 is a flow diagram of a method according to one embodiment;

FIG. 7 illustrates a computer system according to one embodiment; and

FIG. 8 illustrates a computer readable medium according to one embodiment of the present disclosure.

### DETAILED DESCRIPTION

In exemplary embodiments, a workload of a system is increased by increments over time to test a reliability or a stress tolerance of the system and identify faults in the system caused by the increased stress.

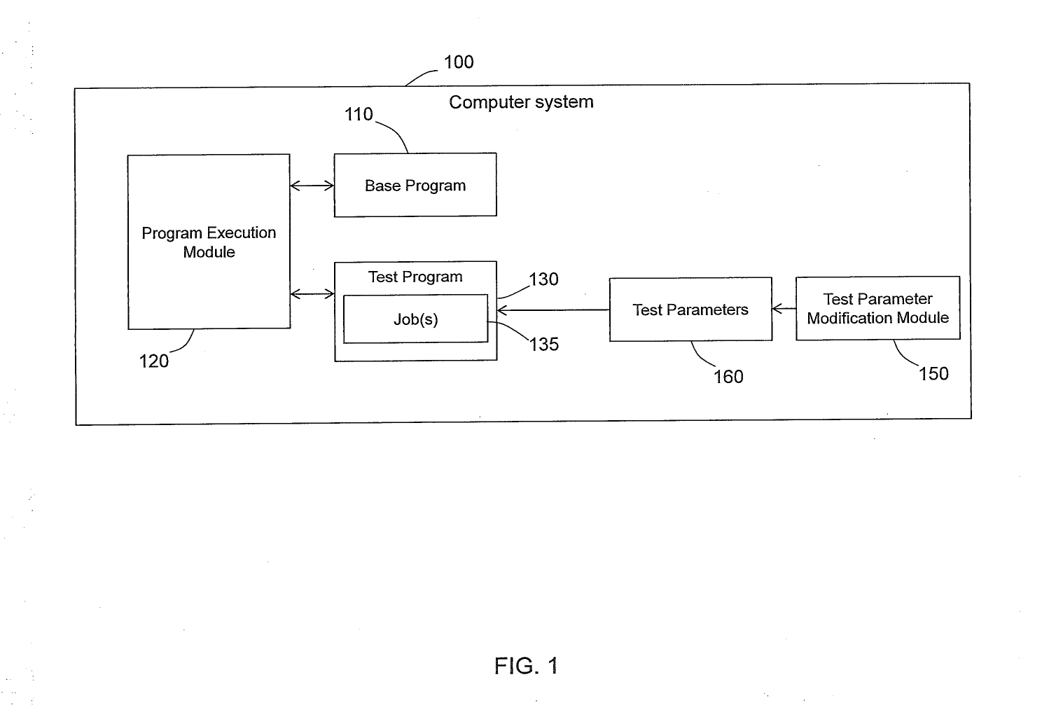

FIG. 1 is a block diagram of a computer system 100 according to an embodiment of the present disclosure. The computer system 100 includes a base program 110 executed by the program execution module 120. The base program 110 may include one or more of an operating system (O/S), middleware, and applications. The program execution module 120 may include one or more central processing units (CPUs), logic units, memory, and other circuitry for executing software systems, programs, etc.

The computer system 100 further includes a test program 130. The test program 130 may comprise one or more jobs 135 to be performed by the base program 110. The jobs 135 may comprise operations and instructions such as read and write operations, I/O operations, or any other type of operation performed by the computer system 100.

The computer system 100 further includes a test parameter modification module 150 by which a user may adjust test parameters 160 of the test program 130. For example, a user may adjust a duration of a test, a rate of increase of a workload in a test, a type of job or mix of jobs performed in the test, or any other test parameters 160. The test program 130 may be updated with the adjusted test parameters 160.

In one embodiment a test may be performed to gauge a strain or stress tolerance or reliability of the computer system 100 running the base program 110 by gradually increasing a number of jobs 135 performed by the computer system 100 until an error is detected. In an embodiment in which the reliability of the computer system 100 is tested by gradually increasing the number of jobs 135 performed by the computer system 100, a user may enter into the test parameter modification module 150 test parameter information to set test parameters 160, such as a percentage increase in jobs provided by the test program 130 to be performed and a job number limit, if any, to trigger an end to the test or to trigger an increase in the number of jobs 135 to be run by the base program 110.

The program execution module 120 begins running the base program 110, and the test program 130 provides the jobs 135 to the base program 110 as the base program 110 is run by the program execution module 120. Upon completion of the jobs 135, a predetermined percentage of the jobs 135 are replicated automatically according to the test parameters 160. For example, prior to initiating the first run of the test program 130, a user may indicate that 10% of the jobs 135 should be replicated after each run of the test program 130. In one embodiment, the jobs 135 include instructions to self-replicate upon execution. In another embodiment, the test program 130 replicates the predetermined percentage of jobs 135 after each run of the jobs 135 by the computer system 100.

The process of running the test program 130 on the base program 110 and replicating the predetermined percentage of jobs 135 after each run may be continued until an error is detected. Since the number of jobs 135 is gradually incremented over time, the level of workload, which in this embodiment corresponds to a number of jobs 135 run by the base program 110, causing the error is easy to determine, and the error may be isolated and corrected.

In some embodiments, the test parameters 160 include a maximum number of jobs 135 to be executed per run. In such an embodiment, the number of jobs 135 is gradually increased after each run, as discussed above, until the job number limit specified in the test parameters 160 is reached, at which time the test program 130 terminates. In another embodiment, the jobs 135 run continuously at a same workload for a predetermined period of time specified by the test parameters 160. After the predetermined period of time has elapsed, the workload may be increased by increasing the number of jobs 135 by a predetermined percentage specified by the test parameters 160. The test program 130 may be re-run by the base program 110 using the increased number of jobs of the test program 130. In this embodiment, once a job 135 has been run by the computer system 100, it is re-run without increasing the number of jobs 135 run by the computer system 100 until the predetermined period of time has passed. Only after the predetermined period of time has passed is the number of jobs 135 increased and the test program 130 re-run based on the increased number of jobs 135.

In embodiments of the present disclosure, the test parameters 160 may be set prior to running the test program 130 so that the test program 130 automatically increases a workload of the base program 120 until a termination condition is detected, such as an error, a predetermined period of time, or a predetermined number of jobs 135 executed. The workload of the base program 110 as a result of the running of the test program 130 may be increased automatically by the computer system 100 without requiring a user to increase the workload or re-run the test program 130. Accordingly, from the perspective of the user, test parameters are set, the test is initiated, and a result is provided corresponding to a detected error or other termination condition. The computer system 100 automatically and gradually increases its workload until the termination condition is detected, without requiring user input to adjust the workload. In addition, the workload of the base program 110 may be pre-set by the test parameters 160 to be increased incrementally or gradually, so that when an error is detected, the error may be quickly identified.

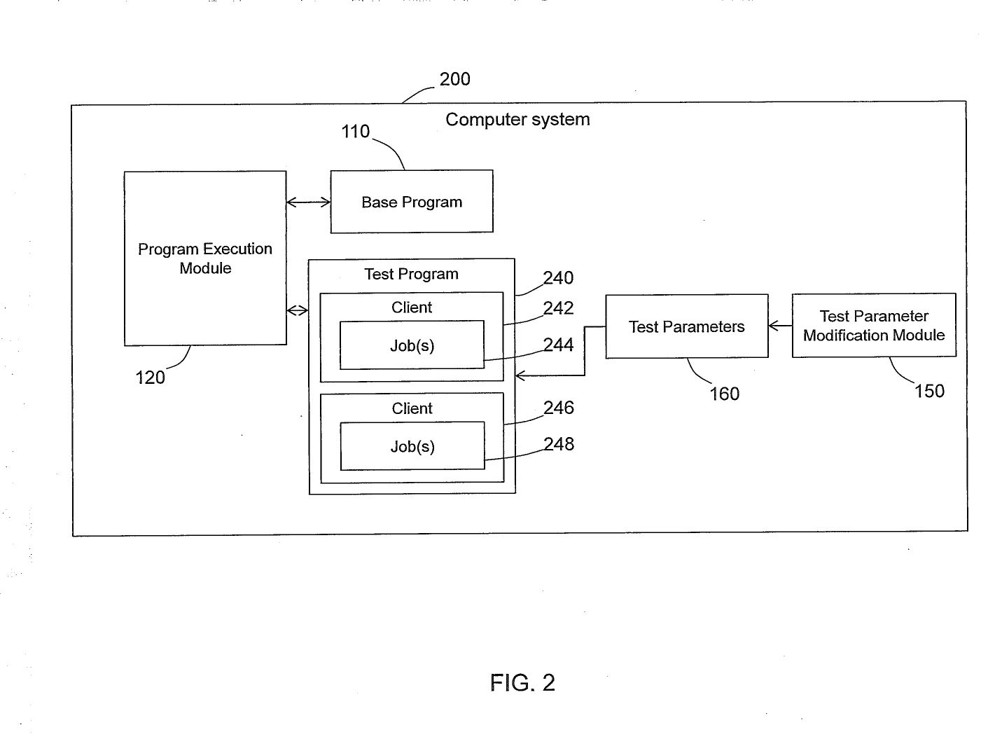

FIG. 2 illustrates a block diagram of a computer system 200 according to another embodiment of the present disclosure. In the computer system 200, the test program 240 may be configured to increase the workload of the base program 110 by gradually increasing a number of clients that access the base program 110. In FIG. 2, the test program 240 is represented as having a client 242 and a client 246, each corresponding to one or more jobs 244 and 248 to be run by the base program 110. However, it is understood that the test program 240 may simulate any number of clients, and in embodiments of the present disclosure, the test program 240 may increase a workload of the base program 110 by gradually increasing the number of clients that access the base program 110 over a period of time.

In operation, a user may access the test parameter modification module 150 to generate test parameters 160 set the rate at which the number of clients simulated by the test program 240 should be increased during testing. The user may also set test parameters 160 to indicate a maximum number of clients to be simulated by the test program 240. For example, the computer system 200 may be configured to support with hardware only a predetermined number of client computers, and the maximum number of clients to be simulated may correspond to the number of client computers physically capable of being supported by the computer system 200. In addition to providing test parameters regarding client simulation, the test parameters may also include job percentage increases, test program run times prior to increasing clients and/or jobs, maximum jobs to be run, or any other parameter.

In operation, the program execution module 120 begins running the base program 110, and the test program 130 simulates one or more clients 242 and 246 to access the base program 110. The clients 242 and 246 may each run respective jobs 244 and 248, which may include read/write operations, I/O operations, or any other operation performed by the computer system 200 and the clients 242 and 246.

Upon completion of a test condition, which may correspond to a number of jobs completed, a period of time elapsed, or any other predetermined condition, the test program 240 may increase the number of simulated clients and the test program 240 may again be run by the base program 110 using the increased number of simulated clients.

The process of running the test program 240 on the base program 110 and increasing the number of clients after each run may be continued until an error is detected. Since the number of clients is gradually incremented over time, the level of workload, which in this embodiment corresponds to a number of clients simulated by the test program 240 causing the error, is easy to determine, and the error may be isolated and corrected.

While FIGS. 1 and 2 illustrate increasing a number of jobs and clients as a means of increasing a workload of a base program 110, embodiments of the present disclosure encompass any type of instruction, unit of programming, or simulation that would increase a workload of a base program, such as an operating system, middleware, or application. Some additional examples of types of measures of a workload include started tasks, simulated terminals, simulated devices, and simulated users, although embodiments of the present disclosure are not limited to these examples.

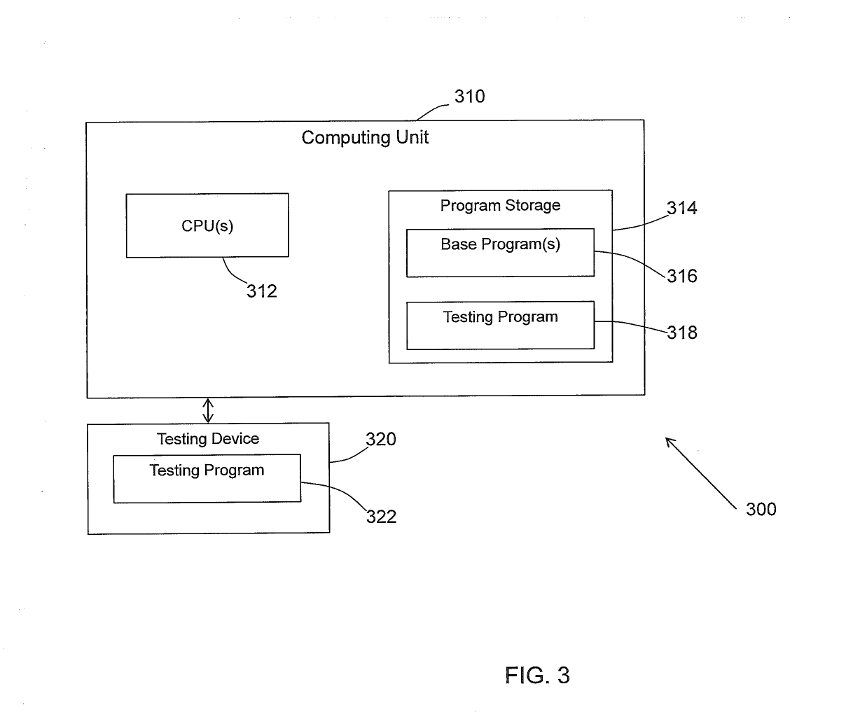

FIG. 3 is a block diagram of a computer system 300 according to an embodiment of the present disclosure. The computer system 300 includes a computing unit 310 having one or more central processing units (CPUs) 312 and program storage 314. The program storage 316 includes at least one base program 316 and may further include a testing program 318 for testing a reliability or stress tolerance of the base program or programs 316. Alternatively, a testing device 320 having a testing program 322 stored therein may be connected to the computing unit 310 and may cause the one or more CPUs 312 to execute the testing program 322.

The base program(s) 316 may include any number and type of computer program, including operating systems, middleware, and applications for executing any type of operation, according to design considerations of the computing unit 310.

In embodiments of the present disclosure, the testing program 318, or the testing program 322, is configured to test a reliability or stress tolerance of the base program(s) 316 by providing the base program(s) 316 with a workload and gradually increasing the workload over time until a termination condition is detected. For example, the testing program 318 may provide the base programs(s) 316 executed by the CPU(s) 312 with a set number of jobs for execution. Upon completion of the set number of jobs, the testing program may increase the number of jobs in the set, and may re-supply the jobs to the base program(s) 316 for execution. The process of job completion, increasing the number of jobs, and re-supplying the jobs to the base program(s) 316 may be repeated until an error is detected by the testing program 318. Since the number of jobs is incrementally increased, the level of jobs causing the error may be quickly identified, facilitating identification of the cause of the error.

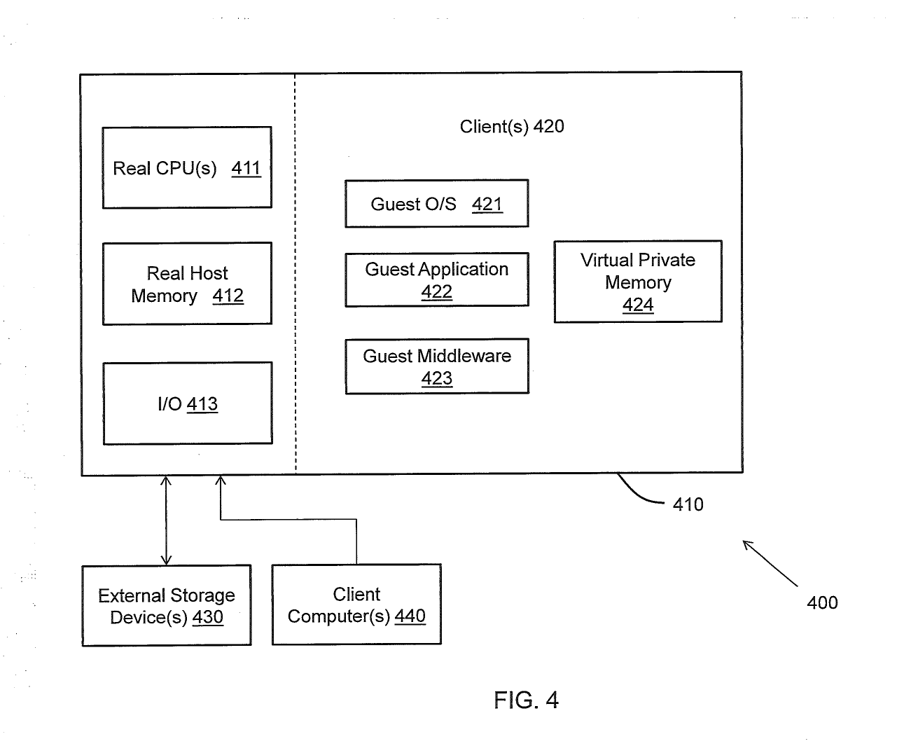

FIG. 4 illustrates a block diagram of a computer system 400 according to another embodiment of the present disclosure. The computer system 400 includes a host computer 410 including one or more real CPUs 411 and real host memory 412. The computer system 400 may further include one or more external storage devices 430 and one or more client computers 440 connected to an I/O interface 413 of the host computer 410 to interact with the host computer 410. The one or more real CPUs 411 may each correspond to a separate processor, or each CPU 411 may correspond to a plurality of processors, processing units, or processing cores, depending upon the design requirements of the computer system 400.

The computer system 400 may include one or more client modules 420. Each client module 420 may include an instance or image of an operating system (O/S) 420 (also referred to as a guest O/S 421). Each client module 420 may further include one or more applications 422, middleware 423, and virtual private memory 424. The guest O/S 421 may be an instance or an image of an O/S stored in the real host memory 412. Similarly, the application 422 and middleware 423 may be instances or images of applications and middleware stored in the real host memory 412. The virtual private memory 424 may be memory addresses within the real host memory 412 designated as corresponding to the client module 420. In operation, each client module 420 may operate separately from each other client module 420, running separate instances of operating systems, applications, and middleware, and storing data in separate memory, or portions of the real host memory 412 designated as corresponding to the respective client modules 420. When a client computer 440 accesses the host computer 410, the CPU 411 may generate or access a client module 420 to correspond to the client computer 440. For example, in one embodiment each client computer 440 may be controlled to correspond to a separate client module 420.

In operation, one of the real host memory 412 and the external storage device 430 may store a test program for testing one or more base programs stored in the real host memory 412 and executed by the one or more real CPUs 411. The base programs to be tested may include one or more of O/S's, applications, and middleware executed by the real CPUs 411. The test program may gradually increase over time a number of jobs to be executed by the host computer 410 until a termination condition is detected. Alternatively, the test program may gradually increase over time a number of clients 420 requiring access to the real CPUs 411. For example, the test program may simulate the connection of client computers 440 to the host computer 410, causing the host computer 410 to generate clients 420 to correspond to the added simulated client computers 440. The test program may simulate operations of the simulated client computers 440, including I/O requests, read/write operations, and running of O/S's, applications, and middleware. While the host computer 410 is configured to be connected to one or more client computers 440, during the reliability testing a testing program may simulate the addition and communications of client computers without the need to physically add new client computers 440.

Upon increasing the number of clients 420, the test program may run for a predetermined period of time to check for errors or any other termination condition. If no errors are detected, the test program may repeat the process of increasing the number of clients 420, re-running the test program, and re-checking for a termination condition until the termination condition is detected.

Although FIG. 4 illustrates a computer system 400 in which one or more clients 420 is generated by a base program in response to the simulation of clients by a test program, it is understood that the test program may also automatically increase the workload of the base program by increasing a number of jobs to be run or by increasing any other measure or metric that would increase the workload of the base program.

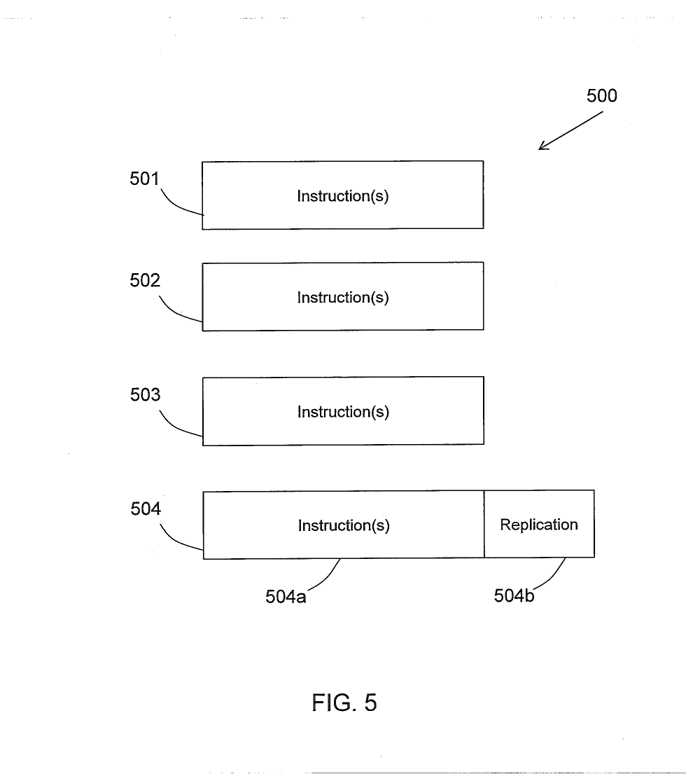

FIG. 5 illustrates an example of a portion of a test program 500 according to an embodiment of the present disclosure. A test program 500 may send to a base program a series of jobs 501, 502, 503 and 504 to be run by the base program. The jobs 501, 502, 503 and 504 may include instructions including read/write instructions, I/O instructions, or any other type of instruction. In one embodiment, job 504 includes an instruction portion 504a including the normal base program instructions, and a replication portion 504b which causes the base program to replicate the job 504. Upon replication, the job 504 and the duplicate are both included in a next run of jobs, causing the number of jobs run by the base program to be gradually incremented over time.

In the embodiment of FIG. 5, one out of four of the jobs 501-504 included the replication portion 504b, indicating that a user or tester desired a 25% workload increase from one job run to the next. In some embodiments, each job 501-504 includes the replication portion 504b, and predefined test parameters control an execution unit to only activate the replication portion of a predetermined number of the jobs. In some embodiments, the percentage of jobs to be replicated is reduced over time. In other words, if a tester is more likely to obtain an error when a larger number of jobs is run, the tester may configure the test parameters to start the testing with a relatively higher replication rate (such as 25%) and over time taper to a relatively lower replication rate (such as 10%). As a result, the change in workload is relatively large when an error is less likely to be detected, and the change in workload decreases as errors are more likely to be detected. Accordingly, it may be easier to detect the cause of the error while efficiently testing the base program under a broad range of workloads.

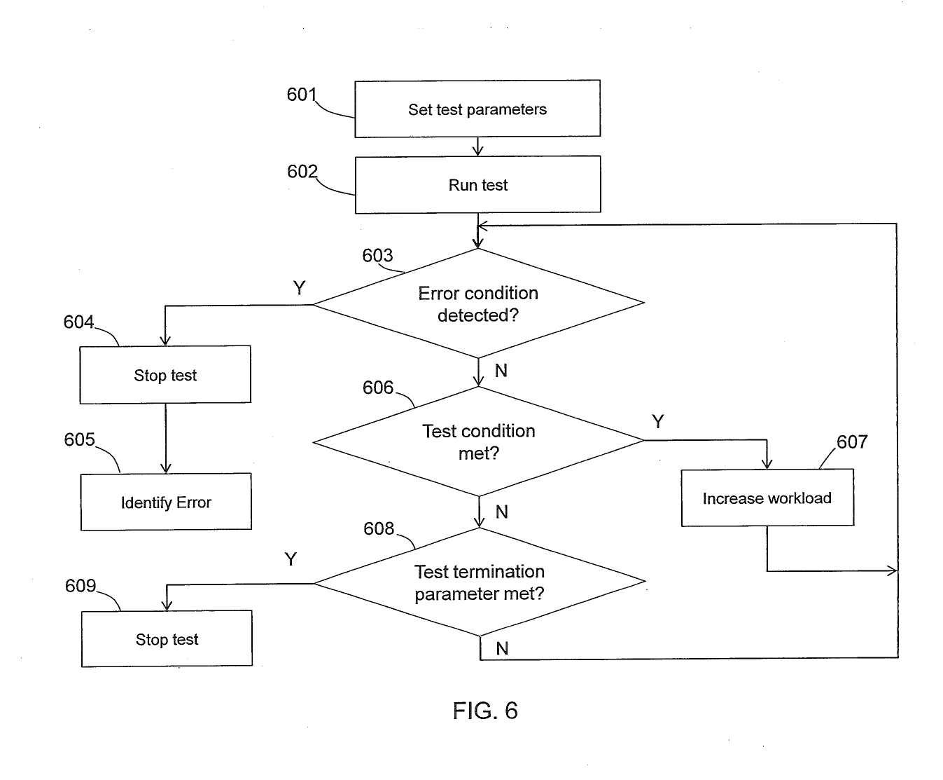

FIG. 6 is a flow diagram of a method according to an embodiment of the present disclosure. In block 601 test parameters are set. The test parameters may be set by a user or other computer program. Test parameters may include setting a type of test condition that triggers an increase in workload during testing, setting a degree of increase in the workload, and setting any conditions that may trigger an end to the test. For example, types of test conditions that may trigger an increase in the workload include a duration of time for which the test is to be run without errors, a number of jobs that is run without errors, a combination of clients and jobs run without errors, or any other test conditions.

Examples of degrees of increases in workloads include setting a percentage or number of jobs to be increased, setting a percentage or number of clients to be increased, or any other measure to increase the workload.

In block 602 the test is run by providing a series of jobs to a base program to be run by the base program. Other types of measures for running the test in addition to, or instead of, jobs include simulated client computers accessing the base program, started tasks, simulated terminals, simulated devices, simulated users or any other measure of supplying a workload to a base program.

In block 603, it is determined whether an error condition is detected. Examples of error conditions may include detection of corrupted data, invalid hardware or software states, crashing or freezing of the base program, perpetual loops, or any other type of error. If an error condition is detected in block 603, the test is stopped in block 604, and the error is identified in block 605.

If no error is detected in block 603, it is determined whether a test condition is met in block 606. Example test conditions include determining whether a predetermined number of jobs has been run, determining whether a predetermined period of time has elapsed, determining whether a predetermined number of started tasks has been run, and determining whether a predetermined number of I/O requests has been run. However, these are provided only as examples of test conditions, and embodiments of the present disclosure encompass any test condition for measuring operation of a base program.

If it is determined in block 606 that the test condition has been met, then the workload of the base program is increased in block 607, and the test continues running. Increasing the workload may include, for example, increasing a number of jobs to be run, increasing a number of started tasks to be run, increasing a number of client computers, terminals, users, or other devices to be simulated, and increasing a number of I/O requests to be run. The foregoing are provided only as examples of increasing a workload of a base program, and embodiments of the present disclosure encompass any measure of increasing the workload of a base program.

If it is determined in block 606 that the test condition is not met, then it may be determined in block 608 whether a test termination parameter is met. If the test termination parameter is met, the test stops in block 609. Otherwise, the test continues by continuing to run jobs on the system. Examples of test termination parameters include a total number of jobs or started tasks run, a number of jobs run in a last run of the test, a number of client computers, terminals, other devices, or users simulated, a total testing time elapsed, and a testing time of the last test run. The foregoing are provided only as examples of test termination parameters, and embodiments of the present disclosure encompass any parameter for terminating a reliability test.

According to the above-described method, a workload of a system or a base program to be tested is gradually or incrementally increased over time. The workload may be increased automatically, or without user intervention, during testing based on parameters that are set prior to testing. Accordingly, testing conditions of a base program may be dynamically changed to test a reliability or stress tolerance of a base program without requiring repeated intervention by a human tester to vary testing conditions, such as a workload of a base program. In addition, since the workload is increased incrementally over time, it is easier to isolate an error caused by the increased workload.

FIG. 6 provides just one example of a method according to embodiments of the present disclosure. There may be many variations to this diagram or the blocks (or operations) described therein without departing from the spirit of the embodiments. For instance, the blocks may be performed in a differing order or blocks may be added, deleted or modified. By way of example, in one embodiment block 608 is omitted and the testing in continued until an error is detected. All of these variations are considered a part of the embodiments of the present disclosure.

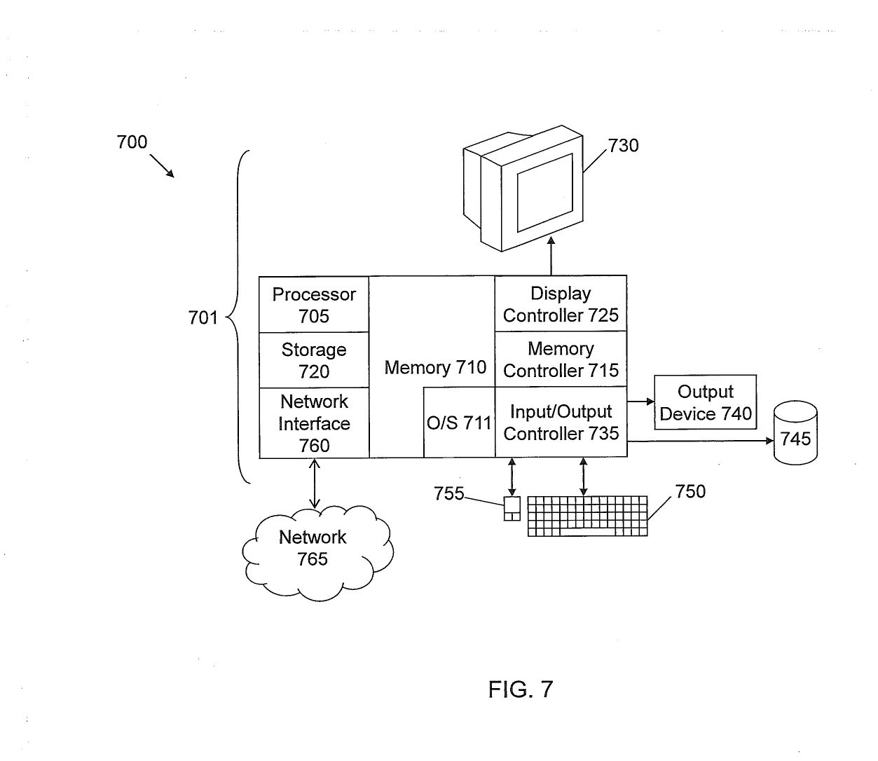

FIG. 7 illustrates a block diagram of a computer system 700 according to an embodiment of the present disclosure. The methods described herein can be implemented in hardware, software (e.g., firmware), or a combination thereof. In an exemplary embodiment, the methods described herein are implemented in hardware as part of the microprocessor of a special or general-purpose digital computer, such as a personal computer, workstation, minicomputer, or mainframe computer. The system 700 therefore may include general-purpose computer or mainframe 701 capable testing a reliability of a base program by gradually increasing a workload of the base program over time.

In an exemplary embodiment, in terms of hardware architecture, as shown in FIG. 7, the computer 701 includes a one or more processors 705, memory 710 coupled to a memory controller 715, and one or more input and/or output (I/O) devices 740, 745 (or peripherals) that are communicatively coupled via a local input/output controller 735. The input/output controller 735 can be, for example, one or more buses or other wired or wireless connections, as is known in the art. The input/output controller 735 may have additional elements, which are omitted for simplicity in description, such as controllers, buffers (caches), drivers, repeaters, and receivers, to enable communications. Further, the local interface may include address, control, and/or data connections to enable appropriate communications among the aforementioned components. The input/output controller 735 may include a plurality of sub-channels configured to access the output devices 740 and 745. The sub-channels may include, for example, fiber-optic communications ports.

The processor 705 is a hardware device for executing software, particularly that stored in storage 720, such as cache storage, or memory 710. The processor 705 can be any custom made or commercially available processor, a central processing unit (CPU), an auxiliary processor among several processors associated with the computer 701, a semiconductor based microprocessor (in the form of a microchip or chip set), a macroprocessor, or generally any device for executing instructions.

The memory 710 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 710 may incorporate electronic, magnetic, optical, and/or other types of storage media. Note that the memory 710 can have a distributed architecture, where various components are situated remote from one another, but can be accessed by the processor 705.

The instructions in memory 710 may include one or more separate programs, each of which comprises an ordered listing of executable instructions for implementing logical functions. In the example of FIG. 7, the instructions in the memory 710 include a suitable operating system (O/S) 711. The operating system 711 essentially controls the execution of other computer programs and provides scheduling, input-output control, file and data management, memory management, and communication control and related services.

In an exemplary embodiment, a conventional keyboard 750 and mouse 755 can be coupled to the input/output controller 735. Other output devices such as the I/O devices 740, 745 may include input devices, for example but not limited to a printer, a scanner, microphone, and the like. Finally, the I/O devices 740, 745 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 700 can further include a display controller 725 coupled to a display 730. In an exemplary embodiment, the system 700 can further include a network interface 760 for coupling to a network 765. The network 765 can be an IP-based network for communication between the computer 701 and any external server, client and the like via a broadband connection. The network 765 transmits and receives data between the computer 701 and external systems. In an exemplary embodiment, network 765 can be a managed IP network administered by a service provider. The network 765 may be implemented in a wireless fashion, e.g., using wireless protocols and technologies, such as WiFi, WiMax, etc. The network 765 can also be a packet-switched network such as a local area network, wide area network, metropolitan area network, Internet network, or other similar type of network environment. The network 765 may be a fixed wireless network, a wireless local area network (LAN), a wireless wide area network (WAN) a personal area network (PAN), a virtual private network (VPN), intranet or other suitable network system and includes equipment for receiving and transmitting signals.

When the computer 701 is in operation, the processor 705 is configured to execute instructions stored within the memory 710, to communicate data to and from the memory 710, and to generally control operations of the computer 701 pursuant to the instructions.

In an exemplary embodiment, the methods of incrementally increasing a system test workload described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

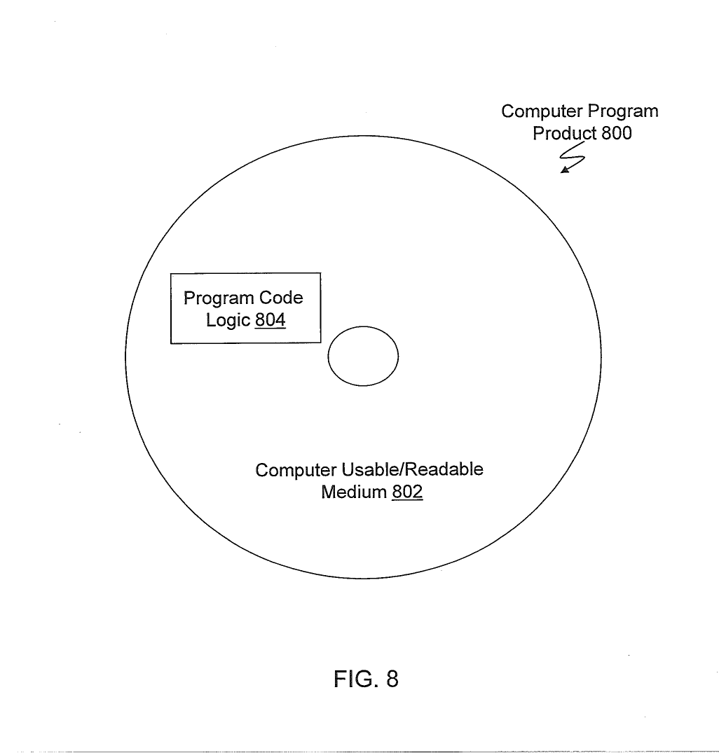

As described above, embodiments can be embodied in the form of computer-implemented processes and apparatuses for practicing those processes. An embodiment may include a computer program product 800 as depicted in FIG. 8 on a computer readable/usable medium 802 with computer program code logic 804 containing instructions embodied in tangible media as an article of manufacture. Exemplary articles of manufacture for computer readable/usable medium 802 may include floppy diskettes, CD-ROMs, hard drives, universal serial bus (USB) flash drives, or any other computer-readable storage medium, wherein, when the computer program code logic 804 is loaded into and executed by a computer, the computer becomes an apparatus for practicing the embodiments. Embodiments include computer program code logic 804, for example, whether stored in a storage medium, loaded into and/or executed by a computer, or transmitted over some transmission medium, such as over electrical wiring or cabling, through fiber optics, or via electromagnetic radiation, wherein, when the computer program code logic 804 is loaded into and executed by a computer, the computer becomes an apparatus for practicing the embodiments. When implemented on a general-purpose microprocessor, the computer program code logic 804 segments configure the microprocessor to create specific logic circuits.

Embodiments of the present disclosure may be implemented by any appropriate architecture. For example, the architecture of International Business Machines (IBM) z/Architecture is utilized to implement the embodiments of the disclosure. A description for the general operations and specifications of the z/Architecture are further described in “IBM® z/Architecture Principles of Operation,” Publication No. SA22-7832-08, 9th Edition, August, 2010 which is hereby incorporated herein by reference in its entirety. IBM is a registered trademark of International Business Machines Corporation, Armonk, N.Y., USA. Other names used herein may be registered trademarks, trademarks or product names of International Business Machines Corporation or other companies.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosed embodiments. Many modifications and variations will be apparent to those of ordinary skill in the art without departing from the scope and spirit of the embodiments of the present disclosure.

While a preferred embodiment has been described above, it will be understood that those skilled in the art, both now and in the future, may make various improvements and enhancements which fall within the scope of the claims which follow.

What is claimed is:

1. A method comprising:
running, by a processor, a reliability testing program of a computer system by running the computer system under a workload; and
gradually and automatically increasing, by the processor, the workload over time until a termination condition is detected.

2. The method of claim 1, wherein gradually increasing the workload includes detecting a test condition and increasing the workload based on detection of the test condition.

3. The method of claim 2, wherein the test condition is one of a predetermined number of executed jobs and a predetermined elapsed time.

4. The method of claim 1, wherein the workload comprises jobs provided by the testing program and executed by the computer system.

5. The method of claim 4, wherein gradually increasing the workload includes replicating a predetermined percentage of initial jobs, upon running the initial jobs, to generate duplicate jobs, and re-running the reliability testing program including both the initial jobs and the duplicate jobs.

6. The method of claim 5, wherein each of the predetermined percentage of initial jobs includes an instruction to replicate itself such that the computer system replicates the predetermined percentage of initial jobs upon running the predetermined percentage of initial jobs.

7. The method of claim 1, wherein the workload comprises clients accessing the computer system, and
wherein gradually increasing the workload includes simulation, by the test program, of an increase in the number of clients accessing the computer system.

8. The method of claim 1, wherein the termination condition is an error in the computer system caused by the workload.

9. A computer program product comprising:
a tangible storage medium readable by a processing circuit of a computer and storing instructions for execution by the processing circuit for performing a method comprising:
running a reliability testing program of a computer system by running the computer system under a workload; and
gradually and automatically increasing, by the processing circuit, the workload over time until a termination condition is detected.

10. The computer program product of claim 9, wherein gradually increasing the workload includes detecting a test condition and increasing the workload based on detection of the test condition, and
wherein the test condition is one of a predetermined number of executed jobs and a predetermined elapsed time.

11. The computer program product of claim 9, wherein the workload comprises jobs provided by the testing program and executed by the computer system.

12. The computer program product of claim 11, wherein gradually increasing the workload includes replicating a predetermined percentage of the jobs upon running of the jobs by the computer system.

13. The computer program product of claim 12, wherein each of the predetermined percentage of jobs includes an instruction to replicate itself such that the running of the predetermined percentage of jobs by the computer system includes replicating the predetermined percentage of jobs.

14. The computer program product of claim 9, wherein the workload comprises clients accessing the computer system, and
wherein gradually increasing the workload includes simulation, by the test program, of an increase in the number of clients accessing the computer system.

15. The computer program product of claim 9, wherein the termination condition is an error in the computer system caused by the workload.

16. A computer system, comprising:
memory and;
at least one central processing unit (CPU) configured to perform a reliability test of the computer system by running the computer system under a workload and gradually and automatically increasing the workload over time until a termination condition is detected.

17. The computer system of claim 16, wherein gradually increasing the workload includes detecting, by the at least one CPU, a test condition and automatically increasing, by the at least one CPU, the workload based on detection of the test condition, and
wherein the test condition is one of a predetermined number of executed jobs and a predetermined elapsed time.

18. The computer system of claim 16, wherein the workload comprises at least one of jobs provided by the testing program and executed by the at least one CPU and clients accessing the computer system.

19. The computer system of claim 18, wherein gradually increasing the workload includes replicating, by the at least one CPU, a predetermined percentage of the jobs upon running of the jobs.

20. The computer system of claim 16, wherein the termination condition is an error in the computer system caused by the workload.
